(19) United States
(12) Patent Application Publication
(10) Pub. No.: US 2021/0156238 A1
(43) Pub. Date: May 27, 2021

(54) HINGED INTERACTIVE DEVICES

(71) Applicant: SHELL OIL COMPANY, Houston, TX (US)

(72) Inventors: DIMITRE D MEHANDJIYSKY, SPRING, TX (US); SARA R FERRIS, HOUSTON, TX (US); KEVIN L MASSARO, SPRING, TX (US)

(21) Appl. No.: 16/636,558

(22) PCT Filed: Oct. 4, 2017
(86) PCT No.: PCT/US17/55180

§ 371 Date: Feb. 4, 2020

(51) Int. Cl. E21B 43/24; H05B 3/56

(52) U.S. Cl. CPC E21B 43/2401; H05B 2214/03; H05B 3/56

(57) ABSTRACT

An insulated conductor (250) may be positioned inside a conduit (312) extending along a length of an opening (312) in a subsurface formation (304). Two or more spring members (318) may be attached to an inside surface of the conduit and electrically coupled to the conduit. The spring members may be attached to the conduit in a portion of the opening distal from a surface (308) of the subsurface formation. The spring members may contact an electrically conductive end termination (316) coupled to a core (252) of the insulated conductor when the end termination is inserted between the spring members. The spring members may exert multi-directional forces on the end termination to maintain contact between the spring members and the end termination. The spring members may electrically couple the core of the insulated conductor to the conduit when the spring members are in contact with the end termination.

### BACKGROUND

### 1. Field of the Invention

The present invention relates to systems and methods used for heating subsurface formations. More particularly, the invention relates to systems and methods using insulated conductors (mineral insulated conductors) to heat subsurface formations containing hydrocarbons as well as systems and methods for electrically connecting conductors in subsurface formations.

### 2. Description of Related Art

Heating hydrocarbon containing formations may be a very effective way of producing oil and gas from heavy oil formations and/or oil shale formations that have a very high carbon number, and in the case of extra-heavy oil formations, a very high viscosity. The heating process may substantially lower the viscosity of heavy oil and, provided that the temperature reached is sufficiently high and is maintained for a sufficient length of time, an in situ upgrading process (IUP) may also occur. The IUP may produce high quality lighter oil and leave heavy coke residue behind in the subsurface. For oil shale, chemical conversion (for example, pyrolysis) via the heating process of the kerogen into hydrocarbons may need to occur before hydrocarbons can be produced from the formation. This process may be known as an in situ conversion process (ICP). One principal type of heater that enables IUP and/or ICP in subsurface formations is a mineral insulated (MI) cable heater.

Heaters such as mineral insulated (MI) cables (for example, insulated conductor heaters) may be placed in subsurface wellbores in hydrocarbon containing formations to provide heat to the formation. There are many different types of heaters which may be used to heat the formation. Examples of in situ processes utilizing downhole heaters are illustrated in U.S. Pat. No. 2,634,961 to Ljungstrom; U.S. Pat. No. 2,732,195 to Ljungstrom; U.S. Pat. No. 2,780,450 to Ljungstrom; U.S. Pat. No. 2,789,805 to Ljungstrom; U.S. Pat. No. 2,923,535 to Ljungstrom; U.S. Pat. No. 4,886,118 to Van Meurs et al.; U.S. Pat. No. 6,688,387 to Wellington et al.; U.S. Pat. No. 8,353,347 to Mason; and U.S. Pat. No. 8,851,170 to Ayodele et al.; each of which is incorporated by reference as if fully set forth herein.

MI cables for use in subsurface applications may be longer, may have larger outside diameters, and may operate at higher voltages and temperatures than what is typical in the MI cable industry. For example, long heaters may require higher voltages to provide enough power to the farthest ends of the heaters. There are many potential problems during manufacture, assembly, installation, and/or operation of long length MI cables in subsurface formations. For example, the coupling of multiple MI cable sections may be needed to make MI cables with sufficient length to reach the depths and distances needed to heat the subsurface efficiently and to couple segments with different functions, such as lead-in cables coupled to heater sections.

Three-phase MI heaters are often used in current configurations for low temperature operations such as flow assurance in production wellbores and/or heavy oil mobilization. Three-phase power may be used to power three MI cables electrically interconnected in a three-phase configuration where, for example, the ends of the cores of the three MI cables are electrically interconnected to couple the cores in parallel. Material costs and/or installation costs for three-phase MI cables may, however, be more costly than simpler single-phase heater designs. At this point, however, there has been little progress in designing a single-phase MI cable that can withstand the mechanical stress in downhole operation and that are simple and easy to install in a variety of wellbores. Thus, there is a need for a single-phase, single cable MI cable designs that are capable of operation at subsurface voltages that are inexpensive and simple to install. Additionally, there is a need for providing reliable and robust electrical connections in the subsurface for single-phase MI cable designs.

### SUMMARY

Embodiments described herein generally relate to systems, methods, and heaters for treating a subsurface formation. Embodiments described herein also generally relate to heaters that have novel components therein. Such heaters can be obtained by using the systems and methods described herein.

In certain embodiments, the invention provides one or more systems, methods, and/or heaters. In some embodiments, the systems, methods, and/or heaters are used for treating a subsurface formation.

In certain embodiments, a system for electrically coupling an insulated conductor to a conduit in an opening in a subsurface formation includes: a conduit extending along a length of an opening in a subsurface formation; an insulated conductor located inside the conduit, wherein the insulated conductor includes: an elongated electrical conductor; an electrical insulator at least partially surrounding the elongated electrical conductor; and an electrically conductive sheath at least partially surrounding the electrical insulator; wherein at least a portion of the elongated electrical conductor is exposed at an end of the elongated electrical conductor configured to be distal from a surface of the subsurface formation, the exposed portion of the elongated electrical conductor being exposed by removing the electrical insulator and the electrically conductive sheath surrounding the elongated electrical conductor in the portion; an electrically conductive end termination coupled to the exposed portion of the elongated electrical conductor, wherein the end termination includes an outside diameter substantially similar to an outside diameter of the electrically conductive sheath; two or more spring members attached to an inside surface of the conduit and electrically coupled to the conduit, wherein the spring members are configured to contact the end termination when the end termination is inserted between the spring members, forces exerted by the spring members maintaining contact between the spring members and the end termination, and wherein the spring members electrically couple the elongated electrical conductor to the conduit when the spring members are in contact with the end termination.

In certain embodiments, a method of electrically coupling an insulated conductor to a conduit in an opening in a subsurface formation, includes: coupling an electrically conductive end termination to a core of an insulated conductor heater, wherein the end termination includes an outside diameter substantially similar to an outside diameter of the insulated conductor heater; providing the insulated conductor heater into a conduit extending along a length of an opening in a subsurface formation; and inserting the end termination between two or more spring members attached to an inside surface of the conduit in a portion of the conduit distal from a surface of the subsurface formation, the spring members being electrically coupled to the conduit, wherein the spring members contact the end termination when the end termination is inserted between the spring members, and wherein the spring members maintain contact with the end termination due to forces exerted by the spring members on the end termination; wherein the spring members electrically couple the core of the insulated conductor heater to the conduit when the spring members are in contact with the end termination.

In certain embodiments, an apparatus for electrically coupling an insulated conductor to a conduit in an opening in a subsurface formation includes: a conduit extending along a length of an opening in a subsurface formation; and two or more spring members attached to an inside surface of the conduit and electrically coupled to the conduit, wherein the spring members are attached to the conduit in a portion of the opening distal from a surface of the subsurface formation; wherein the spring members are configured to contact an electrically conductive end termination coupled to a core of an insulated conductor heater when the end termination is inserted between the spring members, forces exerted by the spring members maintaining contact between the spring members and the end termination, and wherein the spring members electrically couple the core of the insulated conductor to the conduit when the spring members are in contact with the end termination.

In further embodiments, features from specific embodiments may be combined with features from other embodiments. For example, features from one embodiment may be combined with features from any of the other embodiments.

In further embodiments, treating a subsurface formation is performed using any of the methods, systems, power supplies, or heaters described herein.

In further embodiments, additional features may be added to the specific embodiments described herein.

### BRIEF DESCRIPTION OF THE DRAWINGS

Features and advantages of the methods and apparatus described herein will be more fully appreciated by reference to the following detailed description of presently preferred but nonetheless illustrative embodiments when taken in conjunction with the accompanying drawings in which:

FIG. 1 shows a schematic view of an embodiment of a portion of an in situ heat treatment system for treating a hydrocarbon containing formation.

FIG. 2 depicts a perspective view representation of an end portion of an embodiment of single cable insulated conductor.

FIG. 3 depicts a cross-sectional side-view representation of an upper portion of an embodiment of a heater positioned in an opening in a subsurface formation.

FIG. 4 depicts a cross-sectional side-view representation of a lower portion of an embodiment of a heater positioned in an opening in a subsurface formation.

FIG. 5 depicts a cross-sectional view of the heater in the opening along section line A-A in FIG. 3.

FIG. 6 depicts a cross-sectional view of the heater in the opening along section line B-B in FIG. 4.

FIG. 7 depicts a cross-sectional representation of an embodiment of an end termination section.

FIG. 8 depicts a cross-sectional side-view representation of a lower portion of an embodiment of a heater positioned in an opening in a subsurface formation with two end termination sections.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to. Additionally, as used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to”.

### DETAILED DESCRIPTION

The following examples are included to demonstrate preferred embodiments. It should be appreciated by those of skill in the art that the techniques disclosed in the examples which follow represent techniques discovered by the inventor to function well in the practice of the disclosed embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosed embodiments.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

The following description generally relates to systems and methods for treating hydrocarbons in the formations. Such formations may be treated to yield hydrocarbon products, hydrogen, and other products.

“Alternating current (AC)” refers to a time-varying current that reverses direction substantially sinusoidally. AC produces skin effect electricity flow in a ferromagnetic conductor.

“Coupled” means either a direct connection or an indirect connection (for example, one or more intervening connections) between one or more objects or components. The phrase “directly connected” means a direct connection between objects or components such that the objects or components are connected directly to each other so that the objects or components operate in a “point of use” manner.

A “formation” includes one or more hydrocarbon containing layers, one or more non-hydrocarbon layers, an overburden, and/or an underburden. “Hydrocarbon layers” refer to layers in the formation that contain hydrocarbons. The hydrocarbon layers may contain non-hydrocarbon material and hydrocarbon material. The “overburden” and/or the “underburden” include one or more different types of impermeable materials. For example, the overburden and/or underburden may include rock, shale, mudstone, or wet/tight carbonate. In some embodiments of in situ heat treatment processes, the overburden and/or the underburden may include a hydrocarbon containing layer or hydrocarbon containing layers that are relatively impermeable and are not subjected to temperatures during in situ heat treatment processing that result in significant characteristic changes of the hydrocarbon containing layers of the overburden and/or the underburden. For example, the underburden may contain shale or mudstone, but the underburden is not allowed to heat to pyrolysis temperatures during the in situ heat treatment process. In some cases, the overburden and/or the underburden may be somewhat permeable.

“Formation fluids” refer to fluids present in a formation and may include pyrolyzation fluid, synthesis gas, mobilized hydrocarbons, and water (steam). Formation fluids may include hydrocarbon fluids as well as non-hydrocarbon fluids. The term “mobilized fluid” refers to fluids in a hydrocarbon containing formation that are able to flow as a result of thermal treatment of the formation.

A “heat source” is any system for providing heat to at least a portion of a formation substantially by conductive and/or radiative heat transfer. For example, a heat source may include electrically conducting materials and/or electric heaters such as an insulated conductor. A heat source may also include systems that generate heat by burning a fuel external to or in a formation. The systems may be surface burners, downhole gas burners, flameless distributed combustors, and natural distributed combustors. In some embodiments, heat provided to or generated in one or more heat sources may be supplied by other sources of energy. The other sources of energy may directly heat a formation, or the energy may be applied to a transfer medium that directly or indirectly heats the formation. It is to be understood that one or more heat sources that are applying heat to a formation may use different sources of energy. Thus, for example, for a given formation some heat sources may supply heat from electrically conducting materials, electric resistance heaters, some heat sources may provide heat from combustion, and some heat sources may provide heat from one or more other energy sources (for example, chemical reactions, solar energy, wind energy, biomass, or other sources of renewable energy). A chemical reaction may include an exothermic reaction (for example, an oxidation reaction). A heat source may also include an electrically conducting material and/or a heater that provides heat to a zone proximate and/or surrounding a heating location such as a heater well.

A “heater” is any system or heat source for generating heat in a well or a near wellbore region. Heaters may be, but are not limited to, electric heaters, burners, combustors that react with material in or produced from a formation, and/or combinations thereof.

“Hydrocarbons” are generally defined as molecules formed primarily by carbon and hydrogen atoms. Hydrocarbons may also include other elements such as, but not limited to, halogens, metallic elements, nitrogen, oxygen, and/or sulfur. Hydrocarbons may be, but are not limited to, kerogen, bitumen, pyrobitumen, oils, natural mineral waxes, and asphaltites. Hydrocarbons may be located in or adjacent to mineral matrices in the earth. Matrices may include, but are not limited to, sedimentary rock, sands, silicilytes, carbonates, diatomites, and other porous media. “Hydrocarbon fluids” are fluids that include hydrocarbons. Hydrocarbon fluids may include, entrain, or be entrained in non-hydrocarbon fluids such as hydrogen, nitrogen, carbon monoxide, carbon dioxide, hydrogen sulfide, water, and ammonia.

An “in situ conversion process” refers to a process of heating a hydrocarbon containing formation from heat sources to raise the temperature of at least a portion of the formation above a pyrolysis temperature so that pyrolyzation fluid is produced in the formation.

An “in situ heat treatment process” refers to a process of heating a hydrocarbon containing formation with heat sources to raise the temperature of at least a portion of the formation above a temperature that results in mobilized fluid, visbreaking, and/or pyrolysis of hydrocarbon containing material so that mobilized fluids, visbroken fluids, and/or pyrolyzation fluids are produced in the formation.

“Insulated conductor” refers to any elongated material that is able to conduct electricity and that is covered, in whole or in part, by an electrically insulating material.

“Pyrolysis” is the breaking of chemical bonds due to the application of heat. For example, pyrolysis may include transforming a compound into one or more other substances by heat alone. Heat may be transferred to a section of the formation to cause pyrolysis.

“Pyrolyzation fluids” or “pyrolysis products” refers to fluid produced substantially during pyrolysis of hydrocarbons. Fluid produced by pyrolysis reactions may mix with other fluids in a formation. The mixture would be considered pyrolyzation fluid or pyrolyzation product. As used herein, “pyrolysis zone” refers to a volume of a formation (for example, a relatively permeable formation such as a tar sands formation) that is reacted or reacting to form a pyrolyzation fluid.

The term “wellbore” refers to a hole in a formation made by drilling or insertion of a conduit into the formation. A wellbore may have a substantially circular cross section, or another cross-sectional shape. As used herein, the terms “well” and “opening,” when referring to an opening in the formation may be used interchangeably with the term “wellbore.”

A formation may be treated in various ways to produce many different products. Different stages or processes may be used to treat the formation during an in situ heat treatment process. In some embodiments, one or more sections of the formation are solution mined to remove soluble minerals from the sections. Solution mining minerals may be performed before, during, and/or after the in situ heat treatment process. In some embodiments, the average temperature of one or more sections being solution mined may be maintained below about 120° C.

In some embodiments, one or more sections of the formation are heated to remove water from the sections and/or to remove methane and other volatile hydrocarbons from the sections. In some embodiments, the average temperature may be raised from ambient temperature to temperatures below about 220° C. during removal of water and volatile hydrocarbons.

In some embodiments, one or more sections of the formation are heated to temperatures that allow for movement and/or visbreaking of hydrocarbons in the formation. In some embodiments, the average temperature of one or more sections of the formation are raised to mobilization temperatures of hydrocarbons in the sections (for example, to temperatures ranging from 100° C. to 250° C., from 120° C. to 240° C., or from 150° C. to 230° C.).

In some embodiments, one or more sections are heated to temperatures that allow for pyrolysis reactions in the formation. In some embodiments, the average temperature of one or more sections of the formation may be raised to pyrolysis temperatures of hydrocarbons in the sections (for example, temperatures ranging from 230° C. to 900° C., from 240° C. to 400° C. or from 250° C. to 350° C.).

Heating the hydrocarbon containing formation with a plurality of heat sources may establish thermal gradients around the heat sources that raise the temperature of hydrocarbons in the formation to desired temperatures at desired heating rates. The rate of temperature increase through the mobilization temperature range and/or the pyrolysis temperature range for desired products may affect the quality and quantity of the formation fluids produced from the hydrocarbon containing formation. Slowly raising the temperature of the formation to mobilization temperatures and/or pyrolysis temperatures may allow for the production of high quality, high API gravity hydrocarbons from the formation. Slowly raising the temperature of the formation through the mobilization temperature range and/or pyrolysis temperature range may allow for the removal of a large amount of the hydrocarbons present in the formation as hydrocarbon product.

In some in situ heat treatment embodiments, a portion of the formation is heated to a desired temperature instead of slowly heating the temperature through a temperature range. In some embodiments, the desired temperature is 300° C., 325° C., or 350° C. Other temperatures may be selected as the desired temperature.

Superposition of heat from heat sources allows the desired temperature to be relatively quickly and efficiently established in the formation. Energy input into the formation from the heat sources may be adjusted to maintain the temperature in the formation substantially at a desired temperature.

Products from mobilization of hydrocarbons and/or pyrolysis of hydrocarbons may be produced from the formation through production wells. In some embodiments, the average temperature of one or more sections is raised to mobilization temperatures and hydrocarbons are produced from the production wells. The average temperature of one or more of the sections may be raised to pyrolysis temperatures after production due to mobilization decreases below a selected value. In some embodiments, the average temperature of one or more sections may be raised to pyrolysis temperatures without significant production before reaching pyrolysis temperatures. Formation fluids including pyrolysis products may be produced through the production wells.

In some embodiments, the average temperature of one or more sections may be raised to temperatures sufficient to allow synthesis gas production after mobilization and/or pyrolysis. In some embodiments, hydrocarbons may be raised to temperatures sufficient to allow synthesis gas production without significant production before reaching the temperatures sufficient to allow synthesis gas production. For example, synthesis gas may be produced in a temperature range from about 400° C. to about 1200° C., about 500° C. to about 1100° C., or about 550° C. to about 1000° C. A synthesis gas generating fluid (for example, steam and/or water) may be introduced into the sections to generate synthesis gas. Synthesis gas may be produced from production wells 206.

Solution mining, removal of volatile hydrocarbons and water, mobilizing hydrocarbons, pyrolyzing hydrocarbons, generating synthesis gas, and/or other processes may be performed during the in situ heat treatment process. In some embodiments, some processes may be performed after the in situ heat treatment process. Such processes may include, but are not limited to, recovering heat from treated sections, storing fluids (for example, water and/or hydrocarbons) in previously treated sections, and/or sequestering carbon dioxide in previously treated sections.

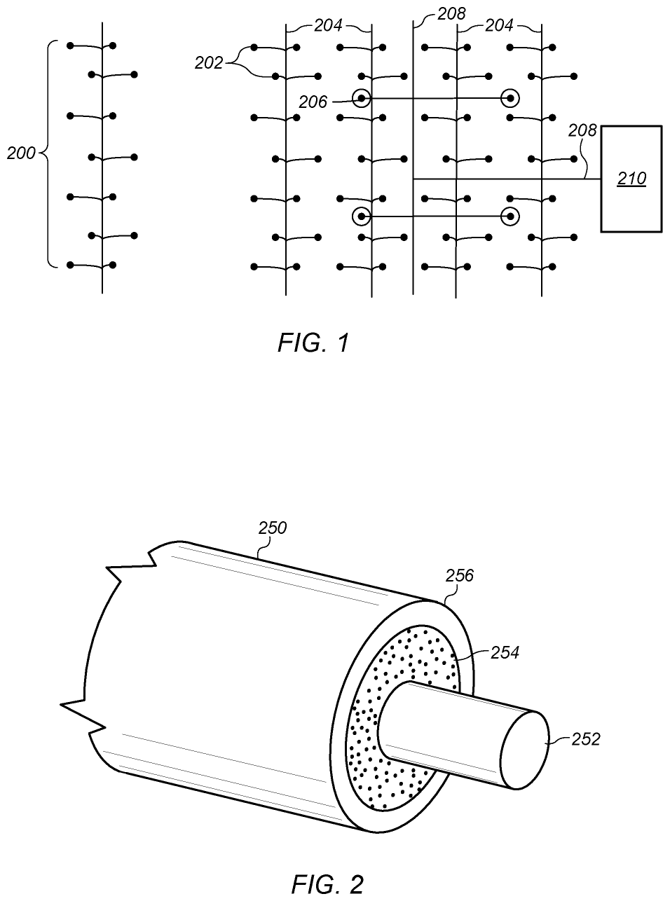

FIG. 1 depicts a schematic view of an embodiment of a portion of an in situ heat treatment system for treating the hydrocarbon containing formation. The in situ heat treatment system may include barrier wells 200. Barrier wells may be used to form a barrier around a treatment area. The barrier may inhibit fluid flow into and/or out of the treatment area. Barrier wells 200 may include, but are not limited to, dewatering wells, vacuum wells, capture wells, injection wells, grout wells, freeze wells, or combinations thereof. In some embodiments, barrier wells 200 are dewatering wells. Dewatering wells may remove liquid water and/or inhibit liquid water from entering a portion of the formation to be heated, or to the formation being heated. In the embodiment depicted in FIG. 1, barrier wells 200 are shown extending only along one side of heat sources 202, but barrier wells 200 typically encircle all heat sources 202 used, or to be used, to heat a treatment area of the formation.

Heat sources 202 may be placed in at least a portion of the formation. In some embodiments, heat sources 202 include heaters such as insulated conductors. Heat sources 202 may also include other types of heaters. Heat sources 202 may provide heat to at least a portion of the formation to heat hydrocarbons in the formation. Energy may be supplied to heat sources 202 through supply lines 204. Supply lines 204 may be structurally different depending on the type of heat source or heat sources used to heat the formation. Supply lines 204 for heat sources 202 may transmit electricity for electric heaters, may transport fuel for combustors, or may transport heat exchange fluid that is circulated in the formation. In some embodiments, electricity for an in situ heat treatment process may be provided by a nuclear power plant or nuclear power plants. The use of nuclear power may allow for reduction or elimination of carbon dioxide emissions from the in situ heat treatment process.

When the formation is heated, the heat input into the formation may cause expansion of the formation and geomechanical motion. Heat sources 202 may be turned on before, at the same time, or during a dewatering process. Computer simulations may model formation response to heating. The computer simulations may be used to develop a pattern and time sequence for activating heat sources 202 in the formation so that geomechanical motion of the formation does not adversely affect the functionality of heat sources 202, production wells 206, and other equipment in the formation.

Heating the formation may cause an increase in permeability and/or porosity of the formation. Increases in permeability and/or porosity may result from a reduction of mass in the formation due to vaporization and removal of water, removal of hydrocarbons, and/or creation of fractures. Fluid may flow more easily in the heated portion of the formation because of the increased permeability and/or porosity of the formation. Fluid in the heated portion of the formation may move a considerable distance through the formation because of the increased permeability and/or porosity. The considerable distance may be over 1000 m depending on various factors, such as permeability of the formation, properties of the fluid, temperature of the formation, and pressure gradient allowing movement of the fluid. The ability of fluid to travel considerable distance in the formation allows production wells 206 to be spaced relatively far apart in the formation.

Production wells 206 may be used to remove formation fluid from the formation. In some embodiments, at least one of the production wells 206 includes heat source 202. Heat source 202 in production well 206 may heat one or more portions of the formation at or near the production well. In some in situ heat treatment process embodiments, the amount of heat supplied to the formation from production well 206 per meter of the production well is less than the amount of heat applied to the formation from heat source 202 that heats the formation per meter of the heat source. Heat applied to the formation from production well 206 may increase formation permeability adjacent to the production well by vaporizing and removing liquid phase fluid adjacent to the production well and/or by increasing the permeability of the formation adjacent to the production well by formation of macro and/or micro fractures.

More than one heat source 202 may be positioned in production well 206. Heat source 202 in a lower portion of production well 206 may be turned off when superposition of heat from adjacent heat sources heats the formation sufficiently to counteract benefits provided by heating the formation with the production well. In some embodiments, heat source 202 in an upper portion of production well 206 may remain on after the heat source in the lower portion of the production well is deactivated. Heat source in the upper portion of production well 206 may inhibit condensation and reflux of formation fluid.

In some embodiments, heat source 202 in production well 206 allows for vapor phase removal of formation fluids from the formation. Providing heating at or through production well 206 may: (1) inhibit condensation and/or refluxing of production fluid when such production fluid is moving in production well 206 proximate the overburden, (2) increase heat input into the formation, (3) increase production rate from production well 206 as compared to a production well without a heat source 202, (4) inhibit condensation of high carbon number compounds (C6 hydrocarbons and above) in production well 206, and/or (5) increase formation permeability at or proximate production well 206.

Subsurface pressure in the formation may correspond to the fluid pressure generated in the formation. As temperatures in the heated portion of the formation increase, the pressure in the heated portion may increase as a result of thermal expansion of in situ fluids, increased fluid generation and vaporization of water. Controlling rate of fluid removal from the formation may allow for control of pressure in the formation. Pressure in the formation may be determined at a number of different locations, such as near or at production wells 206, near or at heat sources 202, or at monitor wells.

In some hydrocarbon containing formations, production of hydrocarbons from the formation may be inhibited until at least some hydrocarbons in the formation have been mobilized and/or pyrolyzed. Formation fluid may be produced from the formation when the formation fluid is of a selected quality. In some embodiments, the selected quality includes an API gravity of at least about 20°, 30°, or 40°. Inhibiting production until at least some hydrocarbons are mobilized and/or pyrolyzed may increase conversion of heavy hydrocarbons to light hydrocarbons. Inhibiting initial production may minimize the production of heavy hydrocarbons from the formation. Production of substantial amounts of heavy hydrocarbons may require expensive equipment and/or reduce the life of production equipment.

In some hydrocarbon containing formations, hydrocarbons in the formation may be heated to mobilization and/or pyrolysis temperatures before substantial permeability has been generated in the heated portion of the formation. An initial lack of permeability may inhibit the transport of generated fluids to production wells 206. During initial heating, fluid pressure in the formation may increase proximate heat sources 202. The increased fluid pressure may be released, monitored, altered, and/or controlled through one or more heat sources 202. For example, selected heat sources 202 or separate pressure relief wells may include pressure relief valves that allow for removal of some fluid from the formation.

In some embodiments, pressure generated by expansion of mobilized fluids, pyrolysis fluids or other fluids generated in the formation may be allowed to increase although an open path to production wells 206 or any other pressure sink may not yet exist in the formation. The fluid pressure may be allowed to increase towards a lithostatic pressure. Fractures in the hydrocarbon containing formation may form when the fluid approaches the lithostatic pressure. For example, fractures may form from heat sources 202 to production wells 206 in the heated portion of the formation. The generation of fractures in the heated portion may relieve some of the pressure in the portion. Pressure in the formation may have to be maintained below a selected pressure to inhibit unwanted production, fracturing of the overburden or underburden, and/or coking of hydrocarbons in the formation.

After mobilization and/or pyrolysis temperatures are reached and production from the formation is allowed, pressure in the formation may be varied to alter and/or control a composition of formation fluid produced, to control a percentage of condensable fluid as compared to non-condensable fluid in the formation fluid, and/or to control an API gravity of formation fluid being produced. For example, decreasing pressure may result in production of a larger condensable fluid component. The condensable fluid component may contain a larger percentage of olefins.

In some in situ heat treatment process embodiments, pressure in the formation may be maintained high enough to promote production of formation fluid with an API gravity of greater than 20°. Maintaining increased pressure in the formation may inhibit formation subsidence during in situ heat treatment. Maintaining increased pressure may reduce or eliminate the need to compress formation fluids at the surface to transport the fluids in collection piping 208 or other conduits to treatment facilities 210.

Maintaining increased pressure in a heated portion of the formation may surprisingly allow for production of large quantities of hydrocarbons of increased quality and of relatively low molecular weight. Pressure may be maintained so that formation fluid produced has a minimal amount of compounds above a selected carbon number. The selected carbon number may be at most 25, at most 20, at most 12, or at most 8. Some high carbon number compounds may be entrained in vapor in the formation and may be removed from the formation with the vapor. Maintaining increased pressure in the formation may inhibit entrainment of high carbon number compounds and/or multi-ring hydrocarbon compounds in the vapor. High carbon number compounds and/or multi-ring hydrocarbon compounds may remain in a liquid phase in the formation for significant time periods. The significant time periods may provide sufficient time for the compounds to pyrolyze to form lower carbon number compounds.

Generation of relatively low molecular weight hydrocarbons is believed to be due, in part, to autogenous generation and reaction of hydrogen in a portion of the hydrocarbon containing formation. For example, maintaining an increased pressure may force hydrogen generated during pyrolysis into the liquid phase within the formation. Heating the portion to a temperature in a pyrolysis temperature range may pyrolyze hydrocarbons in the formation to generate liquid phase pyrolyzation fluids. The generated liquid phase pyrolyzation fluids components may include double bonds and/or radicals. Hydrogen (H₂) in the liquid phase may reduce double bonds of the generated pyrolyzation fluids, thereby reducing a potential for polymerization or formation of long chain compounds from the generated pyrolyzation fluids. In addition, H₂ may also neutralize radicals in the generated pyrolyzation fluids. H₂ in the liquid phase may inhibit the generated pyrolyzation fluids from reacting with each other and/or with other compounds in the formation.

Formation fluid produced from production wells 206 may be transported through collection piping 208 to treatment facilities 210. Formation fluids may also be produced from heat sources 202. For example, fluid may be produced from heat sources 202 to control pressure in the formation adjacent to the heat sources. Fluid produced from heat sources 202 may be transported through tubing or piping to collection piping 208 or the produced fluid may be transported through tubing or piping directly to treatment facilities 210. Treatment facilities 210 may include separation units, reaction units, upgrading units, fuel cells, turbines, storage vessels, and/or other systems and units for processing produced formation fluids. Treatment facilities 210 may form transportation fuel from at least a portion of the hydrocarbons produced from the formation. In some embodiments, the transportation fuel may be jet fuel, such as JP-8.

In certain embodiments, insulated conductors (for example, MI (mineral insulated) cables) are used as electric heater elements for heaters or heat sources 202 used in treatment of a subsurface formation. FIG. 2 depicts a perspective view representation of an end portion of an embodiment of a typical insulated conductor 250 (for example, an MI cable) with a single core 252. Insulated conductor 250 may include core 252, electrical insulator 254, and jacket 256. Core 252 may resistively heat when an electrical current passes through the core. Alternating current and/or direct current may be used to provide power to core 252 such that core 252 resistively heats.

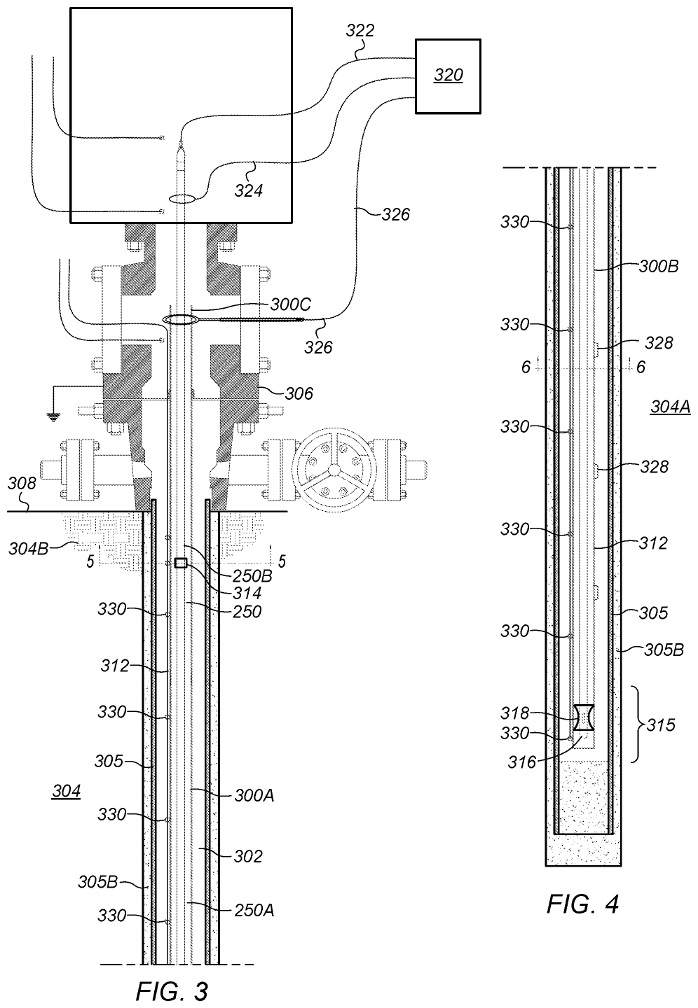

In some embodiments, electrical insulator 254 inhibits current leakage and arcing to jacket 256. Electrical insulator 254 may thermally conduct heat generated in core 252 to jacket 256. Jacket 256 may radiate or conduct heat to a subsurface formation (for example, formation 304 depicted in FIGS. 3 and 4). The dimensions of core 252, electrical insulator 254, and jacket 256 of insulated conductor 250 may be selected such that insulated conductor 250 has enough strength to be self supporting even at upper working temperature limits. Such an insulated conductor 252 may be suspended from a wellhead (for example, wellhead 306 shown in FIG. 3) or supports positioned near an interface between an overburden and a hydrocarbon containing layer.

Insulated conductor 250 may be designed to operate at voltages above 1000 volts, above 1500 volts, or above 2000 volts and may operate for extended periods without failure at elevated temperatures, such as over 650° C. (about 1200° F.), over 700° C. (about 1290° F.), or over 800° C. (about 1470° F.). Insulated conductor 250 may be designed so that a maximum voltage level at a typical operating temperature does not cause substantial thermal and/or electrical breakdown of electrical insulator 254. Insulated conductor 250 may be designed such that jacket 256 does not exceed a temperature that will result in a significant reduction in corrosion resistance properties of the jacket material. In certain embodiments, insulated conductor 250 may be designed to reach temperatures within a range between about 650° C. and about 900° C. Insulated conductors 250 having other operating ranges may be formed to meet specific operational requirements.

As shown in FIG. 2, single cable insulated conductor 250 may have a single core 252. In some embodiments, insulated conductor 250 has two or more cores 252. For example, a single cable insulated conductor 250 may have three cores. Each core 252 may be made of metal or another electrically conductive material. The material used to form core 252 may include, but not be limited to, nichrome, copper, nickel, carbon steel, stainless steel, and combinations or alloys thereof. In certain embodiments, core 252 is chosen to have a diameter and a resistivity at operating temperatures such that its resistance, as derived from Ohm's law, makes it electrically and structurally stable for the chosen power dissipation per meter, the length of the heater, and/or the maximum voltage allowed for the core material. Core 252 may be an elongated electrical conductor. “Elongated electrical conductor” may be generally defined as an electrical conductor that has a very long length as compared to their width or diameter.

Electrical insulator 254 may be made of a variety of materials. Commonly used materials may include, but are not limited to, MgO, Al₂O₃, Zirconia, BeO, different chemical variations of Spinels, and combinations thereof. MgO may provide good thermal conductivity and electrical insulation properties. The desired electrical insulation properties include low leakage current and high dielectric strength. A low leakage current decreases the possibility of thermal breakdown and the high dielectric strength decreases the possibility of arcing across electrical insulator 254. Thermal breakdown can occur if the leakage current causes a progressive rise in the temperature of the insulator leading also to arcing across electrical insulator 254. In certain embodiments, electrical insulator 254 is made from blocks of electrical insulation material. Insulated conductors using blocks of electrical insulation material are described, for example, in U.S. Pat. No. 8,502,120 to Bass et al., which is incorporated by reference as if fully set forth herein.

Jacket 256 may be an outer metallic layer or electrically conductive layer. Jacket 256 may be in contact with hot formation fluids. Jacket 256 may be made of material having a high resistance to corrosion at elevated temperatures. Alloys that may be used in a desired operating temperature range of jacket 256 include, but are not limited to, 304 stainless steel, 310 stainless steel, Incoloy® 800, and Inconel® 600 (Inco Alloys International, Huntington, W. Va., U.S.A.). A thickness of jacket 256 may generally vary between about 1 mm and about 2.5 mm Larger or smaller jacket thicknesses may be used to meet specific application requirements.

In certain embodiments, insulated conductor 250 is used in a heater positioned in an opening in a hydrocarbon containing formation. FIG. 3 depicts a cross-sectional side-view representation of an upper portion of an embodiment of heater 300 positioned in opening 302 in subsurface formation 304. FIG. 4 depicts a cross-sectional side-view representation of a lower portion of an embodiment of heater 300 positioned in opening 302 in subsurface formation 304. The upper portion (portion 300A) of heater 300 is shown in FIG. 3 while the lower portion (portion 300B) of the heater is shown in FIG. 4. Formation 304 may be a hydrocarbon containing formation. Opening 302 may be a wellbore in formation 304. In certain embodiments, opening 302 is positioned in hydrocarbon containing layer 304A of formation 304.

In certain embodiments, as shown in FIGS. 3 and 4, opening 302 includes casing 305. In one embodiment, casing 305 is an 8″ diameter Schedule 40 304 stainless steel pipe. Casing 305 may be fastened (for example, affixed in place) in opening 302 using cement 305B. In some embodiments, as shown in FIG. 4, casing 305 and/or cement 305B may extend beyond the bottom of heater 300 in a distal portion of opening 302 (a portion of the opening distal from the surface of formation 304). Cementing casing 305 in cement 305B in the distal portion of opening 302 may secure the casing in the opening. In some embodiments, heater 300 may be packed in opening 302 with sand, gravel, or other fill material. In some embodiments, opening 302 may be an uncased opening.

In certain embodiments, as shown in FIGS. 3 and 4, heater 300 is placed in opening 302 without a support member. Heater 300 may have sufficient structural strength such that a support member is not needed. For example, heater 300 may have a suitable combination of temperature and corrosion resistance, creep strength, length, thickness (diameter), and metallurgy that will inhibit failure of heater 300 during use. Heater 300 may, in many embodiments, have at least some flexibility to inhibit thermal expansion damage when undergoing temperature changes.

In some embodiments, heater 300 may be supported on a support member positioned within opening 302. The support member may be a cable, rod, or a conduit (for example, a pipe). The support member may be made of a metal, ceramic, inorganic material, or combinations thereof. Because portions of a support member may be exposed to formation fluids and heat during use, the support member may be chemically resistant and/or thermally resistant. Ties, spot welds, and/or other types of connectors may be used to couple or attach heater 300 to the support member at various locations along a length of heater 300. The support member may be attached to wellhead 306 at the surface of formation 304.

In certain embodiments, as shown in FIG. 3, the upper portion (portion 300A) of heater 300 is supported in wellhead 306. Wellhead 306 may be positioned at or near surface 308 of formation 304. In certain embodiments, formation 304 includes overburden 304B between surface 308 and hydrocarbon containing layer 304A. In certain embodiments, heater 300 includes lead-in portion 300C. Lead-in portion 300C may be portions of heater 300 in overburden 304B and wellhead 306. Lead-in portion 300C may provide a lower heat output than portions 300A and 300B of heater 300. Thus, portions 300A and 300B may be heated portions of heater 300 while lead-in portion 300C is a substantially non-heated portion of the heater.

Heater 300 may be a continuous heater extending from the upper portion of the heater (portion 300A, shown in FIG. 3) to the lower portion of the heater (portion 300B, shown in FIG. 4). Heater 300 may extend along a length of opening 302. For example, heater 300 may extend from wellhead 306 to the distal portion of opening 302. In certain embodiments, heater 300 has an overall length (for example, the total length over all portions of the heater) of at least about 100 m in opening 302, at least about 300 m in opening 302, or at least about 500 m in opening 302. In some embodiments, heater 300 is at least about 1000 m or more in length. Longer or shorter heaters 300 may also be used to meet specific application needs. In some embodiments, two or more heaters are coupled (for example, spliced, welded, and/or combinations thereof) to form a longer heater.

FIGS. 3 and 4 depict heater 300 and opening 302 as substantially vertical in formation 304. It is to be understood that heater 300 and/or opening 302 may have any orientation desired in formation 304. For example, heater 300 and/or opening 302 may include substantially horizontal and/or angled portions in formation 304. In some embodiments, the orientation of heater 300 and/or opening 302 is determined by an orientation of hydrocarbon containing layer 304A in formation 304.

In certain embodiments, as shown in FIGS. 3 and 4, heater 300 includes insulated conductor 250 positioned inside conduit 312. Conduit 312 may extend along a length of opening 302. For example, conduit 312 may extend to the distal portion of opening 302, shown in FIG. 4. Conduit 312 may be an electrically conductive conduit including, but not limited to, an electrically conductive pipe or an electrically conductive tubing. Insulated conductor 250 may also extend to the distal portion of opening 302. In certain embodiments, the bottom of conduit 312 (in the distal portion of opening 302) is sealed or otherwise closed off to inhibit formation fluids from entering the bottom of the conduit. In addition, conduit 312 may be sealed along its length to inhibit formation fluids from entering the conduit.

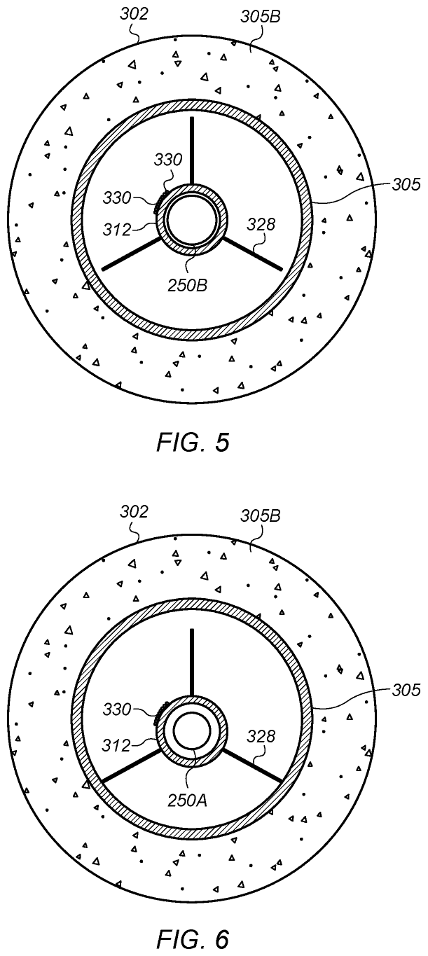

In certain embodiments, as shown in FIGS. 3 and 4, insulated conductor 250 includes heated portion 250A and lead-in portion 250B. Heated portion 250A and lead-in portion 250B may be coupled together (for example, spliced or welded) at coupling 314, as shown in FIG. 4. In some embodiments, coupling 314 is a threaded coupling between heated portion 250A and lead-in portion 250B. Using a threaded coupling between heated portion 250A and lead-in portion 250B may be less expensive and easier to install than a spliced or welded coupling. FIG. 5 depicts a cross-sectional view of heater 300 in opening 302 along section line A-A in FIG. 3. Lead-in portion 250B of insulated conductor 250 is depicted in FIG. 5. FIG. 6 depicts a cross-sectional view of heater 300 in opening 302 along section line B-B in FIG. 4. Heated portion 250A of insulated conductor 250 is depicted in FIG. 6.

In some embodiments, lead-in portion 250B of insulated conductor 250 has a core 252 that is made of a material that has a significantly lower resistance than a core 252 in heated portion 250A of insulated conductor 250. For example, core 252 in lead-in portion 250B may be copper or another highly conductive material. Using a highly conductive core in lead-in portion 250B may inhibit heating in overburden 304B (shown in FIG. 3) and wasting heat energy costs in the overburden. In certain embodiments, the core 252 in lead-in portion 250B of insulated conductor 250 is electrically coupled to a higher resistance core 252 (for example, a nickel-copper alloy core) in heated portion 250B of insulated conductor 250. Core 252 in heated portion 250B may have a resistance suitable for providing heat to hydrocarbon containing layer 304A below overburden 304B.

In certain embodiments, the resistance in various sections of core 252 is adjusted by varying a diameter of core 252 in addition to varying materials of core 252. Varying the diameter of core 252 may vary the diameter of insulated conductor 250. Thus, lead-in portion 250B may have a larger diameter than heated portion 250A. For example, as shown in the embodiment of FIGS. 5 and 6, lead-in portion 250B has a diameter of about 1.63″ (about 4.1 cm) and heated portion 250A has a diameter of about 1.2″(about 3 cm).

In some embodiments, the larger diameter of lead-in portion 250B is due to the lead-in portion having a larger diameter core 252. The larger diameter core 252 may reduce the resistance of insulated conductor 250 in lead-in portion 250B as compared to the resistance of insulated conductor 250 in heated portion 250A. In some embodiments, lead-in portion 250B has the larger diameter in addition to more conductive core materials.

In some embodiments, a transition portion core 252 is electrically coupled between the core 252 in lead-in portion 250B and the core 252 in heated portion 250A. Core 252 in the transition portion may bridge the materials gap between the other cores 252 in lead-in portion 250B and heated portion 250A. In some embodiments, core 252 in the transition portion may bridge the resistance between the other cores 252 in lead-in portion 250B and heated portion 250A. Bridging the resistance may reduce thermal transitions along insulated conductor 250.

As shown in FIGS. 3-6, insulated conductor 250 is positioned inside conduit 312 along a length of the conduit. In one embodiment, as described above, lead-in portion 250B of insulated conductor 250 has a diameter of about 1.63″ (about 4.1 cm) and heated portion 250A of insulated conductor 250 has a diameter of about 1.2″ (about 3 cm). Conduit 312 may be sided to accommodate both lead-in portion 250B and heated portion 250A with at least some clearance between the portions and the conduit. In one embodiment, conduit 312 has an outside diameter of about 2.375″ (about 6 cm) with a thickness of about 0.254″ (about 0.65 cm). Such a conduit 312 may provide a clearance of about 0.119″ (about 0.3 cm) between the conduit and lead-in portion 250B and a clearance of about 0.334″ (about 0.85 cm) between the conduit and heated portion 250A. Other diameters and/or wall thickness of conduit 312, lead-in portion 250B, and/or heated portion 250A may be used as desired depending on, for example, desired heat outputs from heater 300 and/or desired lengths of heater 300.

In certain embodiments, as shown in FIG. 4, core 252 in heated portion 250A of insulated conductor 250 is electrically coupled to the distal end of conduit 312 in end termination section 315 of heater 300. End termination section 315 may be located in a distal portion of opening 302 (for example, the portion of the opening furthest from surface 308). End termination section 315 may also be located at the distal end of heated portion 250A and the distal end of conduit 312 in heater 300.

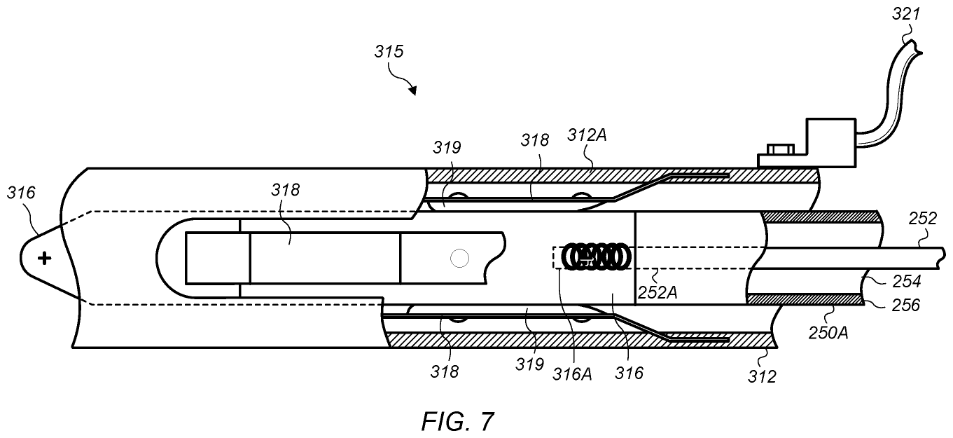

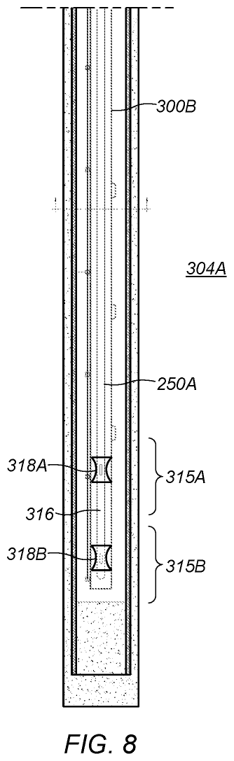

FIG. 7 depicts a cross-sectional representation of an embodiment of end termination section 315. In certain embodiments, end portion 252A of core 252 in heated portion 250A (for example, the distal end of the heated portion) is exposed in end termination section 315. End portion 252A may be exposed by removing portions of electrical insulator 254 and jacket 256 in the distal end of heated portion 250A. Thus, jacket 256 in insulated conductor 250 remains electrically isolated from core 252 and end portion 252A without any electrical connection between core 252 and jacket 256. In certain embodiments, a length of end portion 252A is between about 2 feet (about 0.6 m) and about 10 feet (about 3 m). For example, the length of end portion 252A may be about 5 feet (about 1.5 m). Exposing end portion 252A in end termination section 315 may provide an exposed surface for coupling conduit 312 to the core 252.

In certain embodiments, end portion 252A of core 252 is coupled to end termination 316. End termination 316 may be made of electrically conductive material. In some embodiments, end termination is made of substantially similar material to core 252. For example, end termination 316 may be made of material such as, but not limited to, nichrome, copper, nickel, carbon steel, stainless steel, and combinations or alloys thereof. In certain embodiments, end termination 316 includes opening 316A. Opening 316A may be sized to allow end portion 252A to be inserted in the opening 316A before coupling end termination 316 to the end portion 252A. In some embodiments, as shown in FIG. 7, end portion 252A is coupled to end termination 316 with the end portion 252A inside opening 316A. For example, end portion 252A may be welded or brazed to end termination 316 with the end portion 252A inside opening 316A.

In certain embodiments, end termination 316 has an outside diameter substantially similar to the outside diameter of heated portion 250A and/or the outside diameter of jacket 256 in the heated portion 250A. Thus, when end termination 316 is coupled to end portion 252A of core 252, the combination of the end termination 316 and heated portion 250A has a substantially constant outside diameter and a smooth transition between the heated portion 250A and the end termination 316. The smooth transition may allow insulated conductor 250 to be moved more easily into conduit 312 during installation of the insulated conductor 250.

In certain embodiments, end termination 316 is coupled to end portion 252A of core 252 outside the formation before insulated conductor 250 is installed into opening 302 (for example, at the surface of the formation before installation). During installation of insulated conductor 250 into opening 302, end termination 316 may be provided into end portion 312A of conduit 312 in end termination section 315 (the portion of conduit 312 shown in FIG. 7). In certain embodiments, end portion 312A of conduit 312 in end termination section 315 includes spring members 318 attached to the inside surface of the end portion 312A. In certain embodiments, as shown in FIG. 7, three spring members 318 are attached to the inside surface of end portion 312A. The number of spring members 318 may, however, be varied as needed though typically at least two spring members 318 are needed to maintain contact between the spring members 318 and end termination 316.

In certain embodiments, spring members 318 are attached to the inside surface of end portion 312A with ends of the spring members 318 being embedded in the wall of conduit 312, as shown in FIG. 7, or otherwise attached to the wall of the conduit 312. In some embodiments, spring members 318 are attached to end portion 312A and the end portion 312A is attached to conduit 312. For example, end portion 312A may be a separate piece of conduit attached to the remaining portion of conduit 312. End portion 312A may be, for example, threaded or otherwise attached to conduit 312.

Spring members 318 may be, for example, bow springs or other arc-shaped spring members. As shown in FIG. 7, spring members 318 may be concave-shaped spring members. Spring members 318 may be made of electrically conductive material such as, but not limited to, steel, copper, aluminum, chrome, and combinations thereof. Spring members 318 may be attached to conduit 312 such that the spring members 318 and the conduit 312 are electrically coupled.

In certain embodiments, spring members 318 include angled insertion ends (ends facing the surface of the formation or the insertion end of opening 302). The angled insertion ends of spring members 318 may act as a guide or funnel to guide end termination 316 between the spring members 318 as the end termination 316 (and insulated conductor 250) passes between the spring members 318. For example, if end termination 316 is not centered between spring members 318 as the end termination is moved towards the spring members 318, the angled insertion ends will guide the end termination 316 in between the spring members 318.

When end termination 316 is positioned between spring members 318, as shown in FIG. 7, the spring members 318 contact the end termination 316 and electrically coupled the spring members 318 to the end termination 316. With spring members 318 electrically coupled to end termination 316, conduit 312 is then electrically coupled to end portion 252A and to core 252. Thus, end termination 316 and spring members 318 provide electrical connection between core 252 and conduit 312 at or near the distal end of opening 302 when insulated conductor 250 is positioned inside the conduit 312.

In some embodiments, pads 319 are attached to spring members 318 and the pads 319 contact end termination 316. For example, pads 319 may be fastened to spring members 318. Pads 319 may be made of electrically conductive material such as, but not limited to, steel, copper, aluminum, chrome, and combinations thereof. Pads 319 may be used as electrical contacts between spring members 318 and end termination 316 to provide additional contact area. In some embodiments, pads 319 include malleable material to provide some conformity between the pads 319 and end termination 316 and increase electrical contact between the pads 319 and the end termination 316.

Spring members 318 may exert forces (for example, outward spring forces) on end termination 316. As there are multiple spring members 318 surrounding end termination 316, the spring members 318 may exert forces in multiple directions on the end termination 316. The multi-directional forces exerted by spring members 318 on end termination 316 may maintain contact between the spring members 318 and the end termination 316 as the end termination 316 moves relative to the spring members 318. Thus, spring members 318 may maintain contact (and electrical contact) with end termination 316 as the end termination 316 and insulated conductor 250 move due to thermal expansion and/or contraction during heating of formation 304 using heater 300. Conduit 312 may also move relative to end termination 316 due to thermal expansion and/or contraction during heating of formation 304.

In some embodiments, one or more additional end termination sections 315 may be included on conduit 312. Each additional end termination section 315 may include an additional set of spring members 318 designed to contact end termination 316 at a different location. FIG. 8 depicts a cross-sectional side-view representation of a lower portion of an embodiment of heater 300 positioned in opening 302 in formation 304. As shown in FIG. 8, lower portion 300B of heater 300 includes two end termination sections 315A, 315B.

End termination sections 315A, 315B may be spaced apart along the length of heater 300. For example, end termination sections 315A, 315B may be about 3-4 feet apart. The distance between end termination sections 315A, 315B and the length of end termination 316 may be designed to provide redundant electrical connection between the end termination 316 and conduit 312 and thus between the conduit 312 and core 252 of insulated conductor 250. For example, the distance between end termination sections 315A, 315B and the length of end termination 316 may be selected such that even if insulated conductor 250 thermally expands to a degree that causes end termination 316 to lose contact with spring members 318A in end termination section 315A, the end termination 316 remains in contact with (or comes into contact with) spring members 318B in end termination section 315B.

In some embodiments, conduit 312 is used as an electrical return for insulated conductor 250. FIGS. 3 and 4 depict insulated conductor 250 and conduit 312 electrically coupled in a single phase power configuration. Thus, heater 300 may be used with single phase power source 320, as shown in FIG. 3. Single phase power source 320 may be used to provide alternating current and/or direct current to heater 300. Single phase power source 320 may supply electrical current to core 252 of insulated conductor 250 through power supply cable 322. Ground connector 324 from single phase power source 320 may be coupled to insulated conductor 250, as shown in FIG. 3, to ground the insulated conductor. Conduit 312 may return electrical current to single phase power source 320 through power return cable 326. Power return cable 326 may be a return or neutral for single phase power source 320.

Using single phase power source 320 to power heater 300, current may flow through heater 300 down core 252 (through lead-in portion 250B and heated portion 250A of insulated conductor 250) and return on conduit 312. In certain embodiments, insulated conductor 250 generates a majority of the heat output for heater 300. In some embodiments, insulated conductor 250 generates substantially all or nearly all of the heat output for heater 300. For example, insulated conductor 250 may generate at least about 75%, at least about 90%, or at least about 95% of the heat output for heater 300. Coupling core 252 and conduit 312 in series as the supply and return, respectively, may allow a high voltage and low current to be used in heater 300 for heating formation 304. Additionally, with a large majority of the heat output generated by insulated conductor 250, the voltage on conduit 312 may be relatively low compared to the voltage on core 252 in insulated conductor 250.

In certain embodiments, core 252 and conduit 312 are dimensioned and have materials chosen to provide desired amounts of heat output from heater 300. For example, core 252 and/or conduit 312 may have a desired ratio of (resistive) heat output and/or desired percentages of total (resistive) heat output for heater 300. In certain embodiments, the materials and dimensions of core 252 and conduit 312 are chosen and designed to provide desired heat output properties with selected electrical properties at a selected length for heater 300. For example, in some embodiments, heater 300 is designed to provide heat outputs of at least 250 W/ft, at least 350 W/ft, or at least 400 W/ft. The desired heat output may vary depending, for example, on a time period for heat delivery and/or desired temperatures in the formation. For example, the desired heat output may be higher for initial heating of the formation to heat the formation to higher temperatures more quickly and then the heat output may be lowered to maintain a heating temperature in the formation over a long period of time without burning out the heater.

In certain embodiments, conduit 312 includes ferromagnetic conductor material. For example, conduit 312 may be a carbon steel pipe or a pipe or tube made from another ferromagnetic conductor material. Using ferromagnetic conductor material in conduit 312 may confine propagation of electrical current in the conduit 312 to a skin depth of the ferromagnetic conductor material. Electrically coupling electrical coupler 316 to the inside surface of conduit 312, as depicted in FIG. 4, may confine electrical current to the skin depth on the inside surface of conduit 312. Electrical current may then be inhibited from propagating on the outside surface of conduit 312 if the conduit has a thickness greater than its skin depth. Maintaining current propagation of electrical current on the inside surface of conduit 312 increases the safety of operating heater 300 in formation 300. The inside surface of conduit 312, which is propagating electrical current, is not in contact with formation fluids present in opening 302 as conduit 312 is sealed to inhibit formation fluids from entering the conduit. With no contact between formation fluids and a surface propagating electrical current and having a voltage, there is a reduced likelihood for shorting between conduit 312 and casing 305 (or other conductive surfaces in opening 302).

In some embodiments, as shown in FIG. 7, cable 321 is coupled to or attached to conduit 312. For example, cable 321 may be fastened to conduit 312 using a screw, bolt, or other fastener. Cable 321 may be used to return electrical power from core 252 to the surface of formation 304. For example, cable 321 may be coupled to cable 326 (shown in FIG. 3) and used as the electrical return for insulated conductor 250 instead of conduit 312. In some embodiments, cable 321 and conduit 312 may be used in combination as the electrical return for insulated conductor 250.

In some embodiments, one or more fins 328 are coupled to the outer surface of conduit 312, as shown in FIGS. 4, 5, and 6. Fins 328 may be thermally conductive fins used to increase thermal transfer from heater 300 to formation 304. In some embodiments, fins 328 may be centralizers used to maintain a position of conduit 312 inside casing 305. In some embodiments, fins 328 may inhibit contact between the outer surface of conduit 312 and casing 305.

In some embodiments, one or more thermocouples 330 are coupled to the outer surface of conduit 312, as shown in FIGS. 3-6. Thermocouples 330 may be used to assess a temperature on the outer surface of conduit 312. The assessed temperatures may be used, for example, to assess thermal operation of heater 300. In some embodiments, thermocouples 330 are used to assess temperature distribution along the length of conduit 312. Thermocouples 330 may be placed at one or more known locations along the length of conduit 312 to assess the temperature at each of the known locations.

As shown in FIGS. FIGS. 3-6, conduit 312 may have a substantially constant outside diameter along the length of the conduit. The substantially constant diameter of conduit 312 (and heater 300) may allow heater 300 to be moved through lubricators, rollers, and/or other cable handling equipment without the need for special adapters and/or special techniques. Without the need for special adapters and/or special techniques, heater 300 may be installed downhole inside a pressurized wellbore using a lubricator or similar device that maintains pressure control and wellbore integrity. The pressurized wellbore may be, for example, a live or operating wellbore under pressure. In certain embodiments, heater 300 is installed in a downhole well environment without the need for a support member such as a canister, conduit, or other supporting structure. Such installation allows heater 300 to be installed using, for example, coiled tubing technology such as a coiled tubing unit.

In certain embodiments, heater 300, as described herein, is used for lower temperature heating in formation 304. For example, heater 300 may be used in a production wellbore to maintain fluid mobility for production. In some embodiments, heater 300 is used for mobilizing hydrocarbons in formation 304. For example, heater 300 may be used for mobilizing fluids in a heavy oil or tar sands formation. Heater 300 may have a design that is less expensive and easier to install and operate than other heaters designed for low temperature operations. For example, heater 300 may be less expensive and, in some cases, simpler to install or operate than the three-phase insulated conductors used in some low temperature operations.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a core” includes a combination of two or more cores and reference to “a material” includes mixtures of materials.

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

1. A system for electrically coupling an insulated conductor to a conduit in an opening in a subsurface formation, comprising:
a conduit extending along a length of an opening in a subsurface formation;
an insulated conductor located inside the conduit, wherein the insulated conductor comprises:
an elongated electrical conductor;
an electrical insulator at least partially surrounding the elongated electrical conductor; and
an electrically conductive sheath at least partially surrounding the electrical insulator;
wherein at least a portion of the elongated electrical conductor is exposed at an end of the elongated electrical conductor configured to be distal from a surface of the subsurface formation, the exposed portion of the elongated electrical conductor being exposed by removing the electrical insulator and the electrically conductive sheath surrounding the elongated electrical conductor in the portion;
an electrically conductive end termination coupled to the exposed portion of the elongated electrical conductor, wherein the end termination comprises an outside diameter substantially similar to an outside diameter of the electrically conductive sheath;
two or more spring members attached to an inside surface of the conduit and electrically coupled to the conduit, wherein the spring members are configured to contact the end termination when the end termination is inserted between the spring members, forces exerted by the spring members maintaining contact between the spring members and the end termination, and wherein the spring members electrically couple the elongated electrical conductor to the conduit when the spring members are in contact with the end termination.

2. The heater of claim 1, wherein the elongated electrical conductor is configured to provide resistive heat output to heat at least a portion of the subsurface formation when electrical current is applied to the elongated electrical conductor.

3. The heater of claim 1, wherein the end termination is attached to the conduit in a portion of the opening distal from the surface of the subsurface formation.

4. The heater of claim 1, wherein the spring members comprise arc-shaped spring members.

5. The heater of claim 1, wherein the spring members comprise bow springs.

6. The heater of claim 1, wherein the end termination comprises an opening for the elongated electrical conductor to be inserted into the end termination.

7. The heater of claim 6, wherein the elongated electrical conductor is welded to the end termination in the opening of the end termination.

8. The heater of claim 1, further comprising one or more electrically conductive pads coupled to the spring members, the electrically conductive pads being configured to contact the end termination.

9. The heater of claim 1, further comprising an electrically conductive cable coupled to the conduit, the cable being configured to return electrical current to the surface of the formation.

10. The heater of claim 1, further comprising an additional set of two or more spring members attached to the conduit and spaced apart from the two or more spring members on the conduit, where the additional set of two or more spring members are configured to apply a force to the end termination and contact the end termination when the end termination is inserted between the additional set of two or more spring members.

11. The heater of claim 1, wherein a distal end of the conduit in the opening is sealed to inhibit formation fluids from entering the conduit.

12. The heater of claim 1, wherein the elongated electrical conductor and the conduit are configured to be coupled to a single phase power source.

13. The heater of claim 1, wherein the insulated conductor heater has a length of at least about 300 m.

14. A method of electrically coupling an insulated conductor to a conduit in an opening in a subsurface formation, comprising:
coupling an electrically conductive end termination to a core of an insulated conductor heater, wherein the end termination comprises an outside diameter substantially similar to an outside diameter of the insulated conductor heater;
providing the insulated conductor heater into a conduit extending along a length of an opening in a subsurface formation; and
inserting the end termination between two or more spring members attached to an inside surface of the conduit in a portion of the conduit distal from a surface of the subsurface formation, the spring members being electrically coupled to the conduit, wherein the spring members contact the end termination when the end termination is inserted between the spring members, and wherein the spring members maintain contact with the end termination due to forces exerted by the spring members on the end termination;
wherein the spring members electrically couple the core of the insulated conductor heater to the conduit when the spring members are in contact with the end termination.

15. The method of claim 14, wherein the end termination is inserted between the two or more spring members while the insulated conductor heater is being provided into the conduit.

16. The method of claim 14, wherein coupling the end termination to the core of the insulated conductor heater comprises welding the end termination to the core.

17. The method of claim 14, further comprising exposing the core of the insulated conductor heater before coupling the end termination to the core.

18. The method of claim 14, wherein the spring members maintain contact with the end termination when the end termination moves relative to the conduit.

19. The method of claim 14, wherein the spring members comprise angled insertion ends, and wherein the angled insertion ends funnel the end termination between the spring members as the insulated conductor heater is provided into the conduit.

20. The method of claim 14, further comprising providing the insulated conductor heater into the conduit using a coiled tubing unit without a support member being coupled to the insulated conductor heater.

21. An apparatus for electrically coupling an insulated conductor to a conduit in an opening in a subsurface formation, comprising:
a conduit extending along a length of an opening in a subsurface formation; and
two or more spring members attached to an inside surface of the conduit and electrically coupled to the conduit, wherein the spring members are attached to the conduit in a portion of the opening distal from a surface of the subsurface formation;
wherein the spring members are configured to contact an electrically conductive end termination coupled to a core of an insulated conductor heater when the end termination is inserted between the spring members, forces exerted by the spring members maintaining contact between the spring members and the end termination, and wherein the spring members electrically couple the core of the insulated conductor to the conduit when the spring members are in contact with the end termination.

22. The apparatus of claim 21, wherein the insulated conductor comprises:
the core;
an electrical insulator at least partially surrounding the core; and
an electrically conductive sheath at least partially surrounding the electrical insulator.

23. The apparatus of claim 22, wherein the end termination comprises an outside diameter substantially similar to an outside diameter of the electrically conductive sheath.

24. The apparatus of claim 21, wherein the conduit comprises electrically conductive ferromagnetic material.

25. The apparatus of claim 21, wherein the spring members comprise angled insertion ends that guide insertion of the end termination in between the spring members.

26. The apparatus of claim 21, wherein the spring members are configured to maintain contact with the end termination when the end termination moves relative to the conduit.

27. The apparatus of claim 21, wherein the conduit has a length of at least about 300 m.
